(19) United States
(12) Patent Application Publication
(10) Pub. No.: US 2023/0179389 A1
(43) Pub. Date: Jun. 8, 2023

(54) TRANSMISSION CONFIGURATION INDICATOR STATE UPDATES FOR MULTIPLE COMPONENT CARRIERS

(71) Applicant: QUALCOMM Incorporated, San Diego, CA (US)

(72) Inventors: Ruiming ZHENG, Beijing (CN); Yan ZHOU, San Diego, CA (US); Linhai HE, San Diego, CA (US); Tao LUO, San Diego, CA (US)

(21) Appl. No.: 17/754,864

(22) PCT Filed: Oct. 8, 2020
(86) PCT No.: PCT/CN2020/119862

§ 371 Date: Apr. 14, 2022

(30) Foreign Application Priority Data
Nov. 8, 2019 (WO) PCT/CN2019/116735

(51) Int. Cl. H04L 5/00

(52) U.S. Cl. CPC H04L 5/0098

(57) ABSTRACT

Certain aspects of the present disclosure provide techniques for user equipment (UE) specific transmissions via multiple component carriers. A method that may be performed by a user equipment (UE) includes receiving a signal indicating a plurality of component carriers (CCs) and corresponding transmission configuration indicator states (TCI-states) for the CCs; and receiving a physical channel according to one of the corresponding TCI-states on one or more of the CCs.

### CROSS-REFERENCE TO RELATED APPLICATIONS

This application claims benefit of Application Serial No. PCT/CN2019/116735, filed Nov. 8, 2019, which is herein incorporated by reference in its entirety.

### BACKGROUND

### Field of the Disclosure

Aspects of the present disclosure relate to wireless communications, and more particularly, to techniques for updating transmission configuration indicator states (TCI-states) for user equipment (UE) specific transmissions via multiple component carriers (CCs).

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved utilization of transmission resources.

Certain aspects provide a method for wireless communication performed by a user equipment (UE). The method generally includes receiving a signal indicating a plurality of component carriers (CCs) and corresponding transmission configuration indicator states (TCI-states) for the CCs; and receiving a physical channel according to one of the corresponding TCI-states on one or more of the CCs.

Certain aspects provide a method for wireless communication performed by a base station (BS). The method generally includes transmitting a signal indicating a plurality of component carriers (CCs) and corresponding transmission configuration indicator states (TCI-states) for the CCs; and transmitting a physical channel according to one of the corresponding TCI-states on one or more of the CCs.

Certain aspects provide a method for wireless communication performed by a user equipment (UE). The method generally includes receiving a signal indicating transmission configuration indicator states (TCI-states) for a plurality of transmission reception points (TRPs) to transmit a physical downlink shared channel (PDSCH); and receiving the PDSCH according to the indicated TCI-states from the TRPs.

Certain aspects provide a method for wireless communication performed by a base station (BS). The method generally includes transmitting a signal indicating transmission configuration indicator states (TCI-states) for a plurality of transmission reception points (TRPs) to transmit a physical downlink shared channel (PDSCH); and transmitting the PDSCH according to the indicated TCI-states via the TRPs.

Certain aspects provide an apparatus for wireless communication. The apparatus generally includes a memory and a processor coupled with the memory, the memory and the processor configured to: receive a signal indicating a plurality of component carriers (CCs) and corresponding transmission configuration indicator states (TCI-states) for the CCs; and receive a physical channel according to one of the corresponding TCI-states on one or more of the CCs.

Certain aspects provide an apparatus for wireless communication. The apparatus generally includes a memory and a processor coupled with the memory, the memory and the processor configured to: transmit a signal indicating a plurality of component carriers (CCs) and corresponding transmission configuration indicator states (TCI-states) for the CCs; and transmit a physical channel according to one of the corresponding TCI-states on one or more of the CCs.

Certain aspects provide an apparatus for wireless communication. The apparatus generally includes a memory and a processor coupled with the memory, the memory and the processor configured to: receive a signal indicating transmission configuration indicator states (TCI-states) for a plurality of transmission reception points (TRPs) to transmit a physical downlink shared channel (PDSCH); and receive the PDSCH according to the indicated TCI-states from the TRPs.

Certain aspects provide an apparatus for wireless communication. The apparatus generally includes a memory and a processor coupled with the memory, the memory and the processor configured to: transmit a signal indicating transmission configuration indicator states (TCI-states) for a plurality of transmission reception points (TRPs) to transmit a physical downlink shared channel (PDSCH); and transmit the PDSCH according to the indicated TCI-states via the TRPs.

Certain aspects provide an apparatus for wireless communication. The apparatus generally includes: means for receiving a signal indicating a plurality of component carriers (CCs) and corresponding transmission configuration indicator states (TCI-states) for the CCs; and means for receiving a physical channel according to one of the corresponding TCI-states on one or more of the CCs.

Certain aspects provide an apparatus for wireless communication. The apparatus generally includes: means for transmitting a signal indicating a plurality of component carriers (CCs) and corresponding transmission configuration indicator states (TCI-states) for the CCs; and means for transmitting a physical channel according to one of the corresponding TCI-states on one or more of the CCs.

Certain aspects provide an apparatus for wireless communication. The apparatus generally includes: means for receiving a signal indicating transmission configuration indicator states (TCI-states) for a plurality of transmission reception points (TRPs) to transmit a physical downlink shared channel (PDSCH); and means for receiving the PDSCH according to the indicated TCI-states from the TRPs.

Certain aspects provide an apparatus for wireless communication. The apparatus generally includes: means for transmitting a signal indicating transmission configuration indicator states (TCI-states) for a plurality of transmission reception points (TRPs) to transmit a physical downlink shared channel (PDSCH); and means for transmitting the PDSCH according to the indicated TCI-states via the TRPs.

Certain aspects provide a computer-readable medium for wireless communication performed by a user equipment (UE). The computer-readable medium includes instructions that, when executed by a processing system, cause the processing system to perform operations generally including: receiving a signal indicating a plurality of component carriers (CCs) and corresponding transmission configuration indicator states (TCI-states) for the CCs; and receiving a physical channel according to one of the corresponding TCI-states on one or more of the CCs.

Certain aspects provide a computer-readable medium for wireless communication performed by a base station (BS). The computer-readable medium includes instructions that, when executed by a processing system, cause the processing system to perform operations generally including: transmitting a signal indicating a plurality of component carriers (CCs) and corresponding transmission configuration indicator states (TCI-states) for the CCs; and transmitting a physical channel according to one of the corresponding TCI-states on one or more of the CCs.

Certain aspects provide a computer-readable medium for wireless communication performed by a user equipment (UE). The computer-readable medium includes instructions that, when executed by a processing system, cause the processing system to perform operations generally including: receiving a signal indicating transmission configuration indicator states (TCI-states) for a plurality of transmission reception points (TRPs) to transmit a physical downlink shared channel (PDSCH); and receiving the PDSCH according to the indicated TCI-states from the TRPs.

Certain aspects provide a computer-readable medium for wireless communication performed by a base station (BS). The computer-readable medium includes instructions that, when executed by a processing system, cause the processing system to perform operations generally including: transmitting a signal indicating transmission configuration indicator states (TCI-states) for a plurality of transmission reception points (TRPs) to transmit a physical downlink shared channel (PDSCH); and transmitting the PDSCH according to the indicated TCI-states via the TRPs.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example a base station (BS) and user equipment (UE), in accordance with certain aspects of the present disclosure.

FIG. 3 illustrates an exemplary medium access control (MAC) control element (CE) for activating or deactivating TCI-states for a UE-specific physical channel, according to previously known techniques.

FIG. 4 illustrates an exemplary MAC CE 400 for activating or deactivating a TCI-state for a PDCCH, according to previously known techniques.

FIG. 5 is a flow diagram illustrating example operations for wireless communication by a UE, in accordance with certain aspects of the present disclosure.

FIG. 6 is a flow diagram illustrating example operations for wireless communication by a BS, in accordance with certain aspects of the present disclosure.

FIGS. 7A & 7B are diagrams of exemplary MAC CEs in which a field indicates a list of CCs, in accordance with certain aspects of the present disclosure.

FIG. 8 is a diagram of an exemplary MAC CE in which a bitmap indicates a set of lists of CCs, in accordance with certain aspects of the present disclosure.

FIGS. 9A & 9B are diagrams of exemplary MAC CEs, according to aspects of the present disclosure.

FIG. 10 is a diagram of an exemplary MAC CE in which serving cell IDs are explicitly listed, in accordance with certain aspects of the present disclosure.

FIGS. 11A & 11B are diagrams of exemplary MAC CEs in which a field indicates a list of CCs for a PDCCH transmission, in accordance with certain aspects of the present disclosure.

FIGS. 12A & 12B are diagrams of exemplary MAC CEs, according to aspects of the present disclosure.

FIG. 13 is a diagram of an exemplary MAC CE in which serving cell IDs of a set of CCs are explicitly listed, in accordance with certain aspects of the present disclosure.

FIG. 14 is a flow diagram illustrating example operations for wireless communication that may be performed by a UE, in accordance with certain aspects of the present disclosure.

FIG. 15 is a flow diagram illustrating example operations 1500 for wireless communication that may be performed by a BS, in accordance with certain aspects of the present disclosure.

FIG. 16A illustrates an exemplary medium access control (MAC) control element (CE) for activating or deactivating TCI-states for a UE-specific PDSCH sent via two transmission reception points (TRPs), according to previously known techniques.

FIGS. 16B, 16C, &16D illustrate exemplary octets that may replace the first octet in the MAC CE of FIG. 16A, according to aspects of the present disclosure.

FIG. 17A illustrates an exemplary medium access control (MAC) control element (CE) for activating or deactivating TCI-states for a UE-specific PDSCH sent via two transmission reception points (TRPs), according to previously known techniques.

FIGS. 17B, 17C, &17D illustrate exemplary octets that may replace the first octet in the MAC CE of FIG. 17A, according to aspects of the present disclosure.

FIG. 18 illustrates a communications device that may include various components configured to perform the operations illustrated in FIGS. 5 & 14, in accordance with aspects of the present disclosure.

FIG. 19 illustrates a communications device that may include various components configured to perform the operations illustrated in FIGS. 6 and 15, in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for updating transmission configuration indicator states (TCI-states) for user equipment (UE) specific transmissions via multiple component carriers. In previously known techniques (e.g., 3GPP Release 15 (Rel-15), TCI-state ID for a PDSCH may be updated by a medium access control (MAC) control element (CE) for a single cell. The network sends a MAC CE for each component carrier (CC) configured on the UE receiving the PDSCH, which results in high overhead and large latency, which can impact the network throughput. In frequency range 2 (FR2) beam management aspects, a UE may be expected to receive spatial information on some CCs or all CCs in one transmission. Network may deploy same spatial direction on some of CCs or all CCs in practical environments. A set of TCI-state IDs for UE-specific PDSCH can be activated by a MAC CE for a set of CCs/BWPs at least for the same band.

The following description provides examples of updating transmission configuration indicator states (TCI-states) for user equipment (UE) specific transmissions via multiple component carriers in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

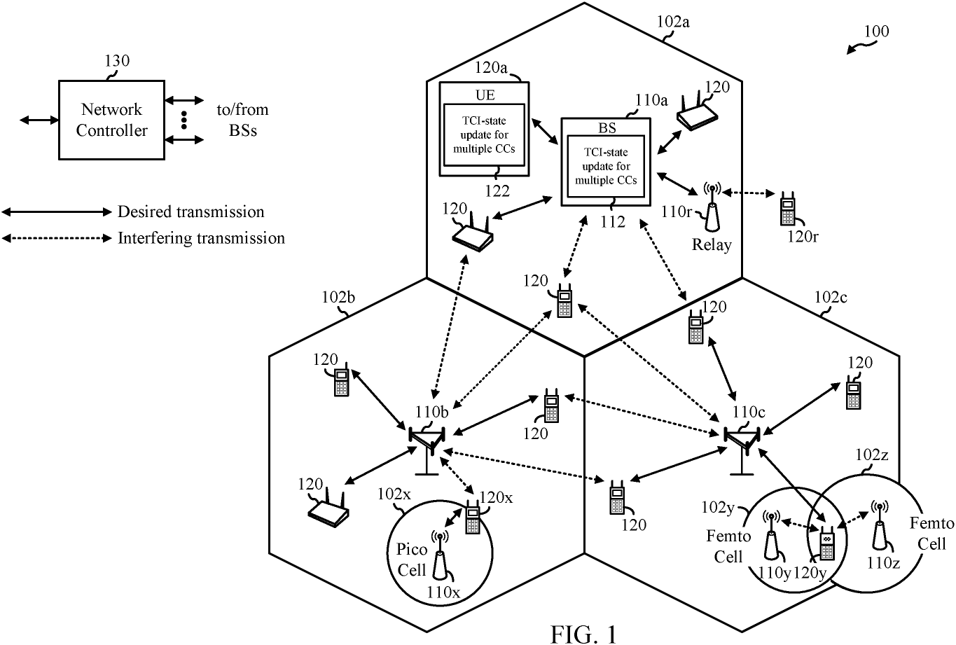

FIG. 1 illustrates an example wireless communication network 100 in which aspects of the present disclosure may be performed. For example, the wireless communication network 100 may be an NR system (e.g., a 5G NR network).

As illustrated in FIG. 1, the wireless communication network 100 may include a number of base stations (BSs) 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

According to certain aspects, the BSs 110 and UEs 120 may be configured for updating transmission configuration indicator states (TCI-states) for user equipment (UE) specific transmissions via multiple component carriers (CCs). As shown in FIG. 1, the BS 110a includes a TCI-state update for multiple CCs manager 112. The TCI-state update for multiple CCs manager 112 may be configured to transmit a signal indicating a plurality of component carriers (CCs) and corresponding transmission configuration indicator states (TCI-states) for the CCs; and transmit a physical channel according to one of the corresponding TCI-states on one or more of the CCs, in accordance with aspects of the present disclosure. In some examples, the TCI-state update for multiple CCs manager 112 may transmit a signal indicating transmission configuration indicator states (TCI-states) for a plurality of transmission reception points (TRPs) to transmit a physical downlink shared channel (PDSCH); and transmit the PDSCH according to the indicated TCI-states via the TRPs. As shown in FIG. 1, the UE 120a includes a TCI-state update for multiple CCs manager 122. The TCI-state update for multiple CCs manager 122 may be configured to receive a signal indicating a plurality of component carriers (CCs) and corresponding transmission configuration indicator states (TCI-states) for the CCs; and receive a physical channel according to one of the corresponding TCI-states on one or more of the CCs, in accordance with aspects of the present disclosure. In some examples, the TCI-state update for multiple CCs manager 122 may receive a signal indicating transmission configuration indicator states (TCI-states) for a plurality of transmission reception points (TRPs) to transmit a physical downlink shared channel (PDSCH); and receive the PDSCH according to the indicated TCI-states from the TRPs.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

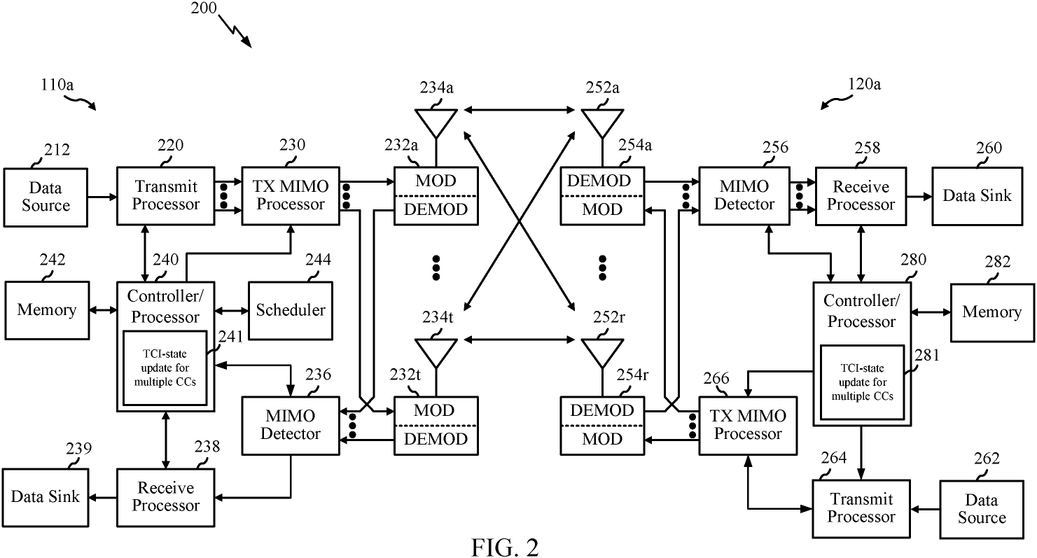

FIG. 2 illustrates example components of BS 110a and UE 120a (e.g., in the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

The controller/processor 280 and/or other processors and modules at the UE 120a may perform or direct the execution of processes for the techniques described herein. For example, as shown in FIG. 2, the controller/processor 240 of the BS 110a has a TCI-state update for multiple CCs manager 241 that may be configured for transmitting a signal indicating a plurality of component carriers (CCs) and corresponding transmission configuration indicator states (TCI-states) for the CCs; and transmitting a physical channel according to one of the corresponding TCI-states on one or more of the CCs, according to aspects described herein. As shown in FIG. 2, the controller/processor 280 of the UE 120a has a TCI-state update for multiple CCs manager 281 that may be configured for receiving a signal indicating a plurality of component carriers (CCs) and corresponding transmission configuration indicator states (TCI-states) for the CCs; and receiving a physical channel according to one of the corresponding TCI-states on one or more of the CCs, according to aspects described herein. Although shown at the Controller/Processor, other components of the UE 120a and BS 110a may be used performing the operations described herein.

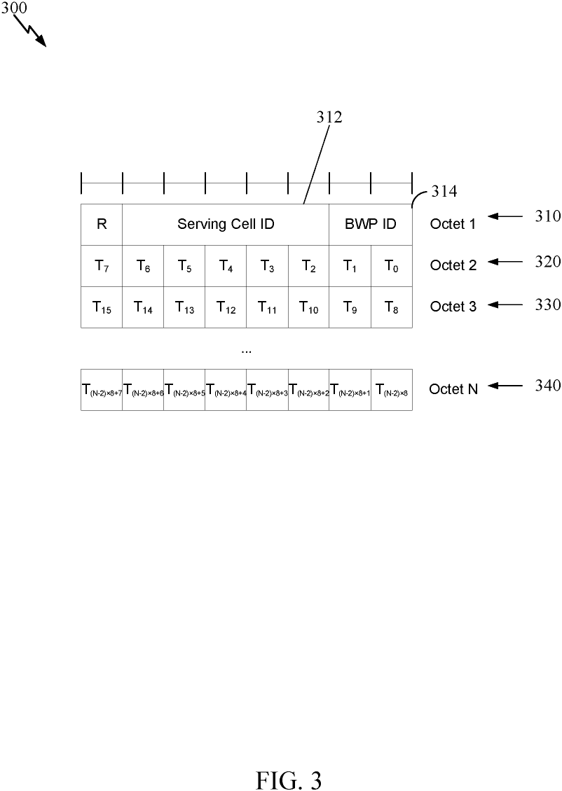

FIG. 3 illustrates an exemplary medium access control (MAC) control element (CE) 300 for activating or deactivating TCI-states for a UE-specific physical downlink shared channel (PDSCH), according to previously known techniques (e.g., Rel-15). The exemplary MAC CE includes a plurality of octets 310, 320, 330, 340, etc. The first octet 310 includes a Serving Cell ID field 312, which is five bits long and indicates the identity of the serving cell for which the MAC CE applies. The first octet also includes a BWP ID field 314 that is two bits long and indicates a downlink (DL) bandwidth part (BWP) for which the MAC CE applies as the codepoint of the downlink control information (DCI) bandwidth part indicator field as specified in TS 38.212 (available from the 3GPP website and other sources). The second octet 320 and later octets include bits indicating TCI states for the serving cell ID and BWP ID. For each Ti, if there is a TCI state with TCI-StateId i as specified in TS 38.331 (also available from 3GPP), then the corresponding Ti field indicates the activation or deactivation status of the TCI state with TCI-StateId i, otherwise (i.e., there is not a TCI state with TCI-StateID i) the MAC entity ignores the Ti field. The Ti field is set to 1 to indicate that the TCI state with TCI-StateId i is activated and mapped to the codepoint of the DCI Transmission Configuration Indication field, as specified in TS 38.214 (available from 3GPP). The Ti field is set to 0 to indicate that the TCI state with TCI-StateId i is deactivated and is not mapped to the codepoint of the DCI Transmission Configuration Indication field. The codepoint to which the TCI State is mapped is determined by its ordinal position among all the TCI States with Ti field set to 1, i.e. the first TCI State with Ti field set to 1 shall be mapped to the codepoint value 0, second TCI State with Ti field set to 1 shall be mapped to the codepoint value 1, and so on. The maximum number of activated TCI states may be 8.

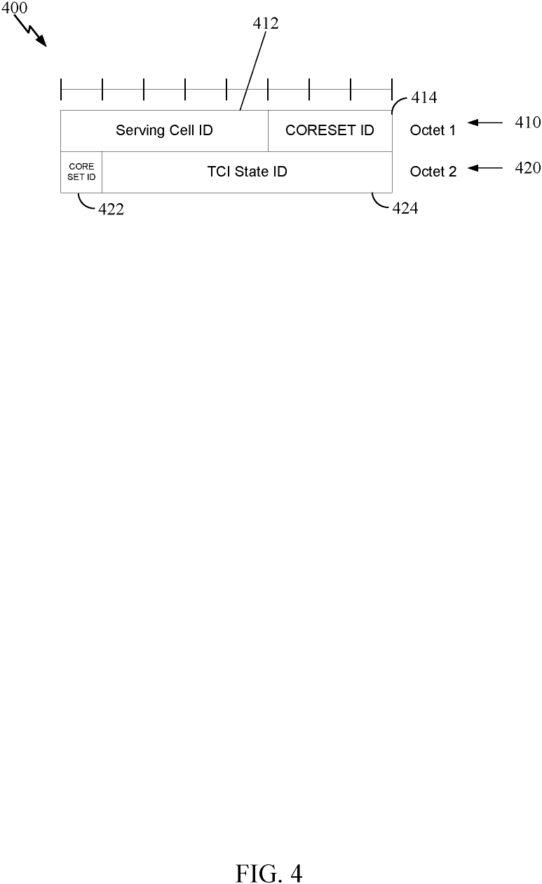

FIG. 4 illustrates an exemplary MAC CE 400 for activating or deactivating a TCI-state for a PDCCH, according to previously known techniques (e.g., Rel-15). The first octet 410 includes a Serving Cell ID field 412 that is five bits long and indicates the identity of the serving cell for which the MAC CE applies. The last three bits 414 and the first bit 422 of the second octet 420 make up the CORESET ID field, which is four bits long and indicates a control resource set (coreset) identified with ControlResourceSetld (e.g., as specified in TS 38.331, available from 3GPP), for which the TCI State is being indicated. If the value of the field is 0, then the field refers to the control resource set configured by controlResourceSetZero (e.g., as specified in TS 38.331). The second octet 420 includes a TCI State ID field which is seven bits long and indicates the TCI state identified by TCI-StateId (e.g., as specified in TS 38.331) applicable to the control resource set identified by the CORESET ID field. If the value of the CORESET ID field is set to 0, then the TCI State ID field indicates a TCI-StateId for a TCI state of the first 64 TCI-states configured by tci-States-ToAddModList and tci-States-ToReleaseList in the PDSCH-Config in the active BWP. If the value of the CORESET ID field is set to a value other than 0, then the TCI State ID field indicates a TCI-StateId configured by tci-StatesPDCCH-ToAddList and tci-StatesPDCCH-ToReleaseList in the controlResourceSet identified by the indicated CORESET ID.

As described above, the previously known techniques enable activating or deactivating a TCI-state on one component carrier (i.e., one BWP of one cell) in one MAC CE. Accordingly, what is needed are techniques and apparatus for updating transmission configuration indicator states (TCI-states) for user equipment (UE) specific transmissions via multiple component carriers.

### Example Transmission Configuration Indicator State Updates for Multiple Component Carriers

Aspects of the present disclosure provide techniques and apparatus for updating transmission configuration indicator states (TCI-states) for user equipment (UE) specific transmissions via multiple component carriers. In certain aspects of the present disclosure, a network may configure one or more lists of component carriers and send a MAC CE changing TCI-states for one or more of the lists. The network may configure the lists via radio resource control (RRC) signaling.

According to certain aspects of the present disclosure, a network may send a MAC CE including cell IDs for a list of cells for which TCI-states are changed.

In certain aspects of the present disclosure, a network may send a MAC CE including a bitmap corresponding to cells configured on a UE, with each bit in the bitmap corresponding to a cell. For a first value of each bit, the TCI-state of the corresponding cell is changed by the MAC CE, and for a second value of each bit, the TCI-state of the corresponding cell is not changed by the MAC CE.

According to certain aspects of the present disclosure, a network may send a physical downlink control channel (PDCCH) that indicates TCI-states for a plurality of transmission reception points to transmit a physical downlink shared channel to a UE, then send the PDSCH according to the indicated TCI-states via the TRPs.

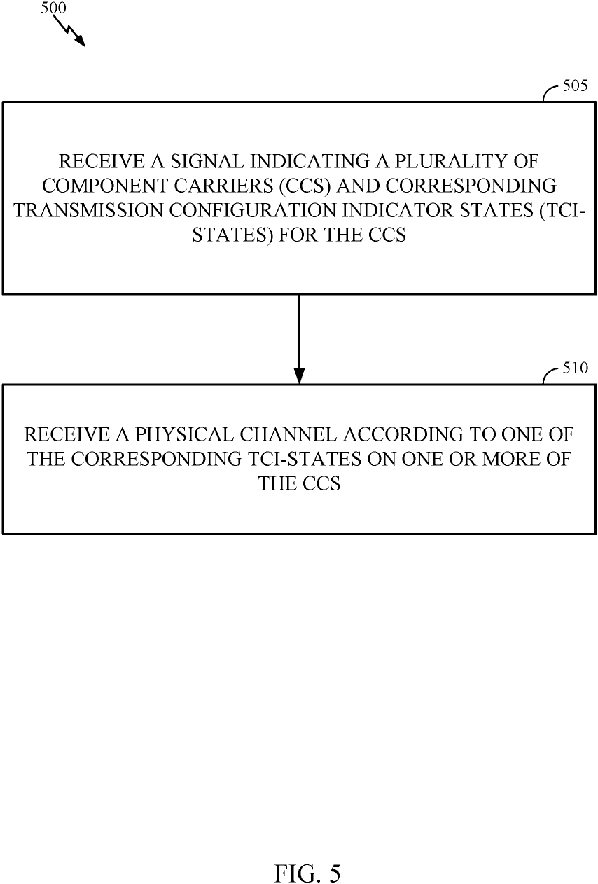

FIG. 5 is a flow diagram illustrating example operations 500 for wireless communication, in accordance with certain aspects of the present disclosure. The operations 500 may be performed, for example, by a UE (e.g., such as a UE 120a in the wireless communication network 100). Operations 500 may be implemented as software components that are executed and run on one or more processors (e.g., controller/processor 280 of FIG. 2). Further, the transmission and reception of signals by the UE in operations 500 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 500 may begin, at block 505, by the UE receiving a signal indicating a plurality of component carriers (CCs) and corresponding transmission configuration indicator states (TCI-states) for the CCs. For example, the UE (e.g., UE 120a shown in FIGS. 1-2) receives a signal indicating a plurality of CCs and corresponding TCI-states for the CCs from a base station (e.g., BS 110a shown in FIGS. 1-2) via antennas 252 and 234. The UE may include one or more processors, such as the receive processor 258 and the controller/processor 280 of FIG. 2, to decode or otherwise process the signal and determine the CCs indicated in the signal and the corresponding TCI states for the CCs. The decoded or processed information may be stored in the data sink 260 or the memory 282.

At block 510, operations 500 continue with the UE receiving a physical channel according to one of the corresponding TCI-states on one or more of the CCs. Continuing the example, the UE (e.g., UE120a of FIGS. 1-2) may, according to one of the indicated CCs and one of the corresponding TCI-states thereon, receive a physical channel (e.g., a PDCCH) via the antennas 252. The physical channel may be processed using the receive processor 258.

According to aspects of the present disclosure, the signal of block 500 may be a medium access control (MAC) control element (CE).

In aspects of the present disclosure, a UE performing operations 500 may receive, via radio resource control (RRC) signaling, a set of lists, each list including one or more of the CCs of block 505, and the signal of block 505 may indicate the plurality of CCs by including an identifier of one of the lists in a field in the signal.

According to aspects of the present disclosure, a UE performing operations 500 may receive, via radio resource control (RRC) signaling, a set of lists, each list including one or more of the CCs, and the signal of block 505 may indicate the plurality of CCs in a bitmap in the signal, wherein each bit in the bitmap indicates whether the signal applies to a corresponding list in the set of lists.

In aspects of the present disclosure, the signal of block 505 may include a bitmap, wherein each bit in the bitmap indicates whether the signal applies to a corresponding cell operating on at least one of the CCs and configured on the UE.

According to aspects of the present disclosure, the signal of block 505 may indicate the plurality of CCs by including a list of cell identifiers (IDs) in the signal, each cell ID corresponding to a cell operating on at least one of the CCs and configured on the UE.

In aspects of the present disclosure the physical channel of block 510 may be a physical downlink control channel (PDCCH).

According to aspects of the present disclosure, the physical channel of block 510 may be a physical downlink shared channel (PDSCH).

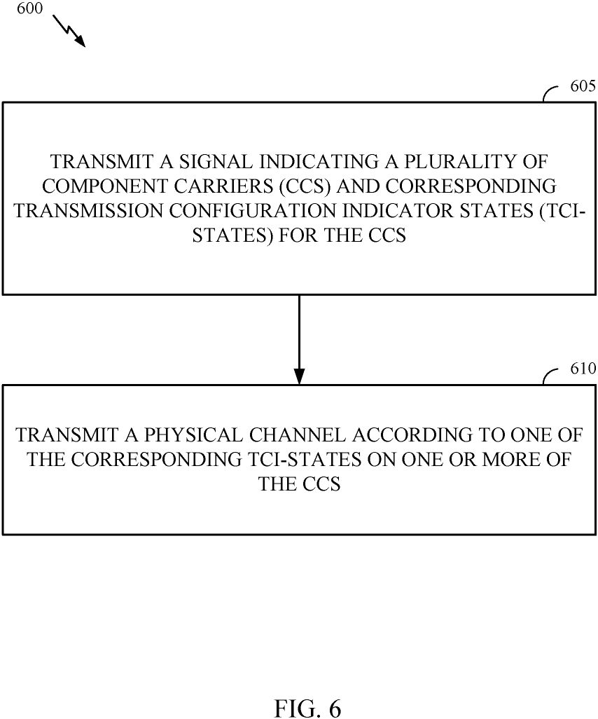

FIG. 6 is a flow diagram illustrating example operations 600 for wireless communication, in accordance with certain aspects of the present disclosure. The operations 600 may be performed, for example, by a BS (e.g., such as the BS 110a in the wireless communication network 100). The operations 600 may be complimentary operations by the BS to the operations 500 performed by the UE. Operations 600 may be implemented as software components that are executed and run on one or more processors (e.g., controller/processor 240 of FIG. 2). Further, the transmission and reception of signals by the BS in operations 600 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 600 may begin, at block 605, by the BS transmitting a signal indicating a plurality of component carriers (CCs) and corresponding transmission configuration indicator states (TCI-states) for the CCs. For example, the BS may be the BS 110a of FIG. 2. The BS 110a may transmit a signal indicating a plurality of CCs and corresponding TCI-states for the CCs via antennas 234. The signal may be generated or encoded by the controller/processor 240 and the transmit processor 220.

At block 610, operations 600 continue with the BS transmitting a physical channel according to one of the corresponding TCI-states on one or more of the CCs. Continuing the example, the BS 110a of FIG. 2 may, according to one of the corresponding TCI-states on one or more of the CCs, transmit a physical channel via the antennas 234.

According to aspects of the present disclosure, the signal of block 600 may be a medium access control (MAC) control element (CE).

In aspects of the present disclosure, a BS performing operations 600 may transmit, via radio resource control (RRC) signaling, a set of lists, each list including one or more of the CCs of block 605, and the BS may indicate the plurality of CCs in the signal of block 605 by including an identifier of one of the lists in a field in the signal.

According to aspects of the present disclosure, a BS performing operations 600 may transmit, via radio resource control (RRC) signaling, a set of lists, each list including one or more of the CCs, and the BS may indicate the plurality of CCs in a bitmap in the signal of block 605, wherein each bit in the bitmap indicates whether the signal applies to a corresponding list in the set of lists.

In aspects of the present disclosure, a BS performing operations 600 may include a bitmap in the signal of block 605, wherein each bit in the bitmap indicates whether the signal applies to a corresponding cell operating on at least one of the CCs and configured on a UE that is intended to receive the signal and physical channel.

According to aspects of the present disclosure, BS performing operations 600 may indicate the plurality of CCs in the signal of block 605 by including a list of cell identifiers (IDs) in the signal, each cell ID corresponding to a cell operating on at least one of the CCs and configured on a UE that is intended to receive the signal and physical channel.

In aspects of the present disclosure the physical channel of block 610 may be a physical downlink control channel (PDCCH).

According to aspects of the present disclosure, the physical channel of block 610 may be a physical downlink shared channel (PDSCH).

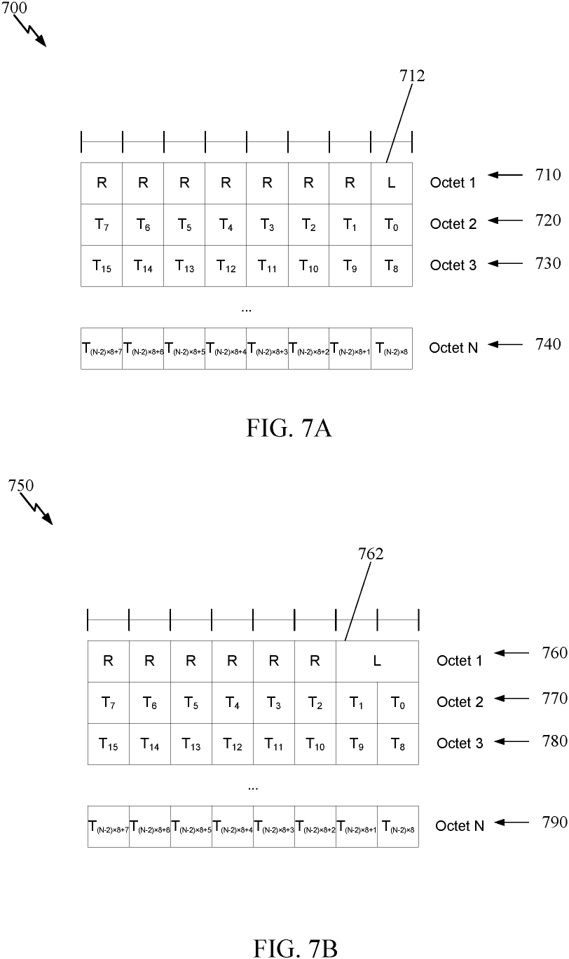

FIGS. 7A & 7B are diagrams of exemplary MAC CEs 700 and 750 in which a field in each MAC CE indicates a list of CCs to which the updated TCI-states in the MAC CE apply. The MAC CEs 700 and 750 may include a list (L) field in a first octet, as shown at 712 in FIG. 7A and at 762 in FIG. 7B. Octets 2 through N, shown at 720, 730, 740, 770, 780, and 790 may be a bitmap corresponding to TCI-states, with each bit indicating whether the corresponding TCI-state is activated or deactivated. The second octets 720 and 770, and later octets 730, 740, 780, and 790, include bits indicating TCI states for the CCs indicated in the MAC CE. For each Ti, if there is a TCI state with TCI-StateId i, then the corresponding Ti field indicates the activation or deactivation status of the TCI state with TCI-StateId i, otherwise (i.e., there is not a TCI state with TCI-StateID i) the MAC entity ignores the Ti field. The Ti field may be set to 1 to indicate that the TCI state with TCI-Stateld i is activated and mapped to the codepoint of the DCI Transmission Configuration Indication field. The Ti field may be set to 0 to indicate that the TCI state with TCI-StateId i is deactivated and is not mapped to the codepoint of the DCI Transmission Configuration Indication field. The codepoint to which the TCI State is mapped may be determined by its ordinal position among all the TCI States with Ti field set to 1, i.e. the first TCI State with Ti field set to 1 may be mapped to the codepoint value 0, second TCI State with Ti field set to 1 may be mapped to the codepoint value 1, and so on. According to aspects of the present disclosure, the network (e.g., a base station) may use radio resource control (RRC) signaling to configure lists of CCs on a UE. The network may send (e.g., via a base station) a MAC CE 700 or 750, which may be an example of the signal in block 505 of FIG. 5 or in block 605 of FIG. 6, that indicates one list identifier of the lists configured by the RRC signaling. The UE may then update the set of TCI-state information for the CCs in the list indicated in the MAC CE. As illustrated at 712 in FIG. 7A, the list (L) field may be a single bit, when the network has configured two lists of CCs on the UE. The L field may be 1, 2 (e.g., as shown at 762 in FIG. 7B), or more bits, depending on how many lists of CCs are configured via RRC by the network per UE.

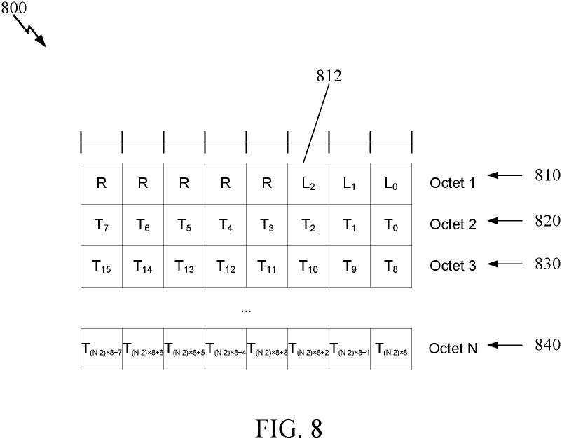

FIG. 8 is a diagram of an exemplary MAC CE 800 in which a bitmap in the first octet 810 of the MAC CE indicates a set of lists of CCs to which the updated TCI-states in the MAC CE apply. The MAC CE 800 may include a set of list (L) fields in the first octet, as shown at 812 in FIG. 8. Octets 2 through N, shown at 820, 830, and 840, may be a bitmap corresponding to TCI-states, with each bit indicating whether the corresponding TCI-state is activated or deactivated. The second octet 820 and later octets 830 and 840 include bits indicating TCI states for the CCs indicated in the MAC CE. For each Ti, if there is a TCI state with TCI-StateId i, then the corresponding Ti field indicates the activation or deactivation status of the TCI state with TCI-StateId i, otherwise (i.e., there is not a TCI state with TCI-StateID i) the MAC entity ignores the Ti field. The Ti field may be set to 1 to indicate that the TCI state with TCI-StateId i is activated and mapped to the codepoint of the DCI Transmission Configuration Indication field. The Ti field may be set to 0 to indicate that the TCI state with TCI-StateId i is deactivated and is not mapped to the codepoint of the DCI Transmission Configuration Indication field. The codepoint to which the TCI State is mapped may be determined by its ordinal position among all the TCI States with Ti field set to 1, i.e. the first TCI State with Ti field set to 1 may be mapped to the codepoint value 0, second TCI State with Ti field set to 1 may be mapped to the codepoint value 1, and so on. According to aspects of the present disclosure, the network (e.g., a base station) may use radio resource control (RRC) signaling to configure lists of CCs on a UE. The network may send (e.g., via a base station) a MAC CE 800, which may be an example of the signal in block 505 of FIG. 5 or in block 605 of FIG. 6, that has a bitmap which indicates one or more of the lists configured by the RRC signaling. The UE may then update the set of TCI-state information for the CCs in the one or more lists indicated in the MAC CE. As illustrated at 812 in FIG. 8, the bitmap list (L) field may be three bits, but the current disclosure is not so limited, and the bitmap may be up to eight bits (i.e., the entire first octet) when the network has configured eight lists of CCs on the UE.

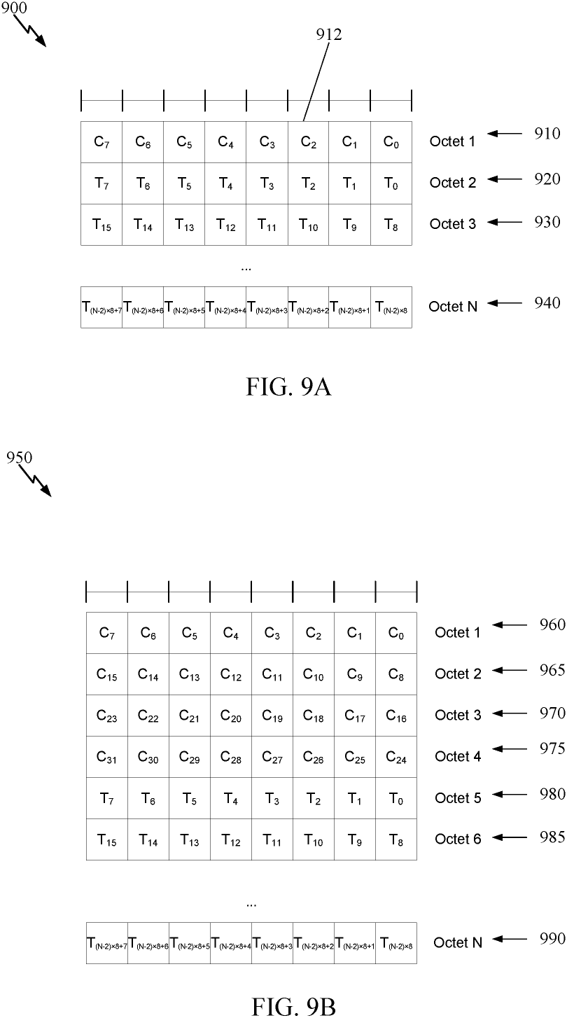

FIGS. 9A & 9B are diagrams of exemplary MAC CEs 900 and 950, according to aspects of the present disclosure. In aspects of the present disclosure, a MAC CE, which may be an example of the signal in block 505 of FIG. 5 or in block 605 of FIG. 6, may provide bitmap-based CC information. As illustrated at 912 in FIG. 9A, the bitmap may include a plurality of C fields, with each C field indicating whether the TCI-states of the MAC CE apply to a corresponding CC configured on the receiving UE. As illustrated in MAC CE 900, in some aspects of the present disclosure, the bitmap may be eight bits, i.e., the first octet 910. In some aspects of the present disclosure, the bitmap may be 32 bits, i.e., the first four octets 960, 965, 970, and 975, as illustrated in MAC CE 950. Octets after the bitmap (octets 920, 930, and 940 in FIG. 9A or octets 980, 985, and 990 in FIG. 9B) may be a bitmap corresponding to TCI-states, with each bit indicating whether the corresponding TCI-state is activated or deactivated. The second octet 920 and later octets 930 and 940 in FIG. 9A include bits indicating TCI states for the CCs indicated in the bitmap in the first octet 910. Similarly, the fifth octet 980 and later octets 985 and 990 in FIG. 9B include bits indicating TCI-states for the CCs indicated in the bitmap in the first four octets 960, 965, 970, and 975. For each Ti, if there is a TCI state with TCI-StateId i, then the corresponding Ti field indicates the activation or deactivation status of the TCI state with TCI-StateId i, otherwise (i.e., there is not a TCI state with TCI-StateID i) the MAC entity ignores the Ti field. The Ti field may be set to 1 to indicate that the TCI state with TCI-StateId i is activated and mapped to the codepoint of the DCI Transmission Configuration Indication field. The Ti field may be set to 0 to indicate that the TCI state with TCI-StateId i is deactivated and is not mapped to the codepoint of the DCI Transmission Configuration Indication field. The codepoint to which the TCI State is mapped may be determined by its ordinal position among all the TCI States with Ti field set to 1, i.e. the first TCI State with Ti field set to 1 may be mapped to the codepoint value 0, second TCI State with Ti field set to 1 may be mapped to the codepoint value 1, and so on.

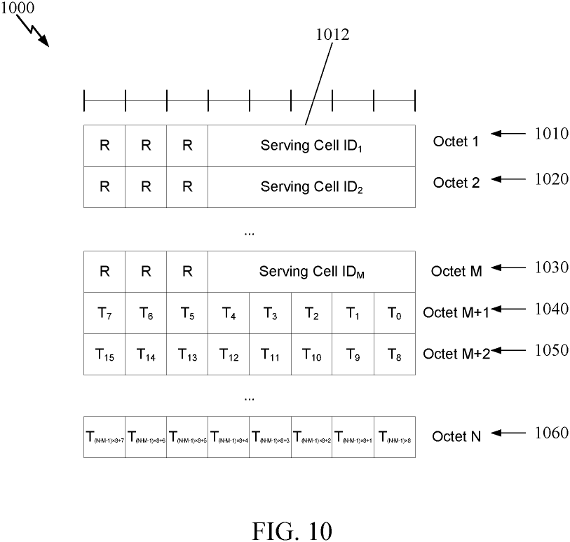

FIG. 10 is a diagram of an exemplary MAC CE 1000 in which serving cell IDs of a set of CCs to which the updated TCI-states in the MAC CE apply are explicitly listed. The MAC CE 1000 may include a set of M serving cell IDs in the first M octets 1010, 1020, and 1030 of the MAC CE, as shown at 1012. The MAC CE Octets M+1 through N, shown at 1040, 1050, and 1060, may be a bitmap corresponding to TCI-states, with each bit indicating whether the corresponding TCI-state is activated or deactivated. The M+1 octet 1040 and later octets 1050 and 1060 include bits indicating TCI states for the CCs indicated by the serving cell IDs in the MAC CE. For each Ti, if there is a TCI state with TCI-StateId i, then the corresponding Ti field indicates the activation or deactivation status of the TCI state with TCI-StateId i, otherwise (i.e., there is not a TCI state with TCI-StateID i) the MAC entity ignores the Ti field. The Ti field may be set to 1 to indicate that the TCI state with TCI-StateId i is activated and mapped to the codepoint of the DCI Transmission Configuration Indication field. The Ti field may be set to 0 to indicate that the TCI state with TCI-StateId i is deactivated and is not mapped to the codepoint of the DCI Transmission Configuration Indication field. The codepoint to which the TCI State is mapped may be determined by its ordinal position among all the TCI States with Ti field set to 1, i.e. the first TCI State with Ti field set to 1 may be mapped to the codepoint value 0, second TCI State with Ti field set to 1 may be mapped to the codepoint value 1, and so on. According to aspects of the present disclosure, the network (e.g., a base station) may use radio resource control (RRC) signaling to configure lists of CCs on a UE. The network may send (e.g., via a base station) a MAC CE 1000, which may be an example of the signal in block 505 of FIG. 5 or in block 605 of FIG. 6. The UE may then update the set of TCI-state information for the CCs corresponding to the serving cell IDs indicated in the MAC CE 1000.

According to aspects of the present disclosure, techniques similar to those described above can be adopted for TCI-state updates for a PDCCH transmitted via multiple component carriers.

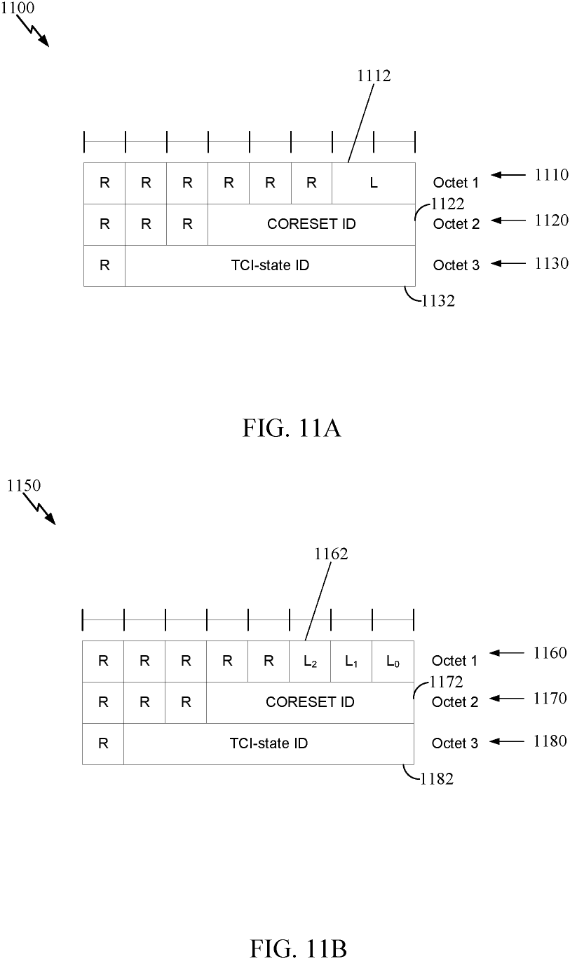

FIGS. 11A & 11B are diagrams of exemplary MAC CEs 1100 and 1150 in which a field indicates a list of CCs to which the updated TCI-states in the MAC CE apply for a PDCCH transmission. The MAC CEs 1100 or 1150 may include a list (L) field in a first octet, as shown at 1112 in FIG. 11A and at 1162 in FIG. 11B. The second octet 1120 or 1170 may include a coreset ID 1122 or 1172 to which the TCI-state in MAC CE applies. The third octet 1130 or 1180 may include a TCI-state ID 1132 or 1182 that identifies the TCI-state to be applied to the PDCCH in the identified coreset. According to aspects of the present disclosure, the network (e.g., a base station) may use radio resource control (RRC) signaling to configure lists of CCs on a UE. The network may send (e.g., via a base station) a MAC CE 1100 or 1150, which may be an example of the signal in block 505 of FIG. 5 or in block 605 of FIG. 6, that indicates one list identifier of the lists configured by the RRC signaling. The UE may then update the set of TCI-state information for the CCs in the list indicated in the MAC CE. As illustrated at 1112 in FIG. 11A, the list (L) field may be two bits, when the network has configured four or fewer lists of CCs on the UE. The L field may be 1, 2 (e.g., as shown at 762 in FIG. 7B), or more bits, depending on how many lists of CCs are configured via RRC by the network per UE. Additionally or alternatively, the L field may be a bitmap which indicates one or more of the lists configured by the RRC signaling. The UE may then update the set of TCI-state information for the CCs in the one or more lists indicated in the MAC CE. As illustrated at 1162 in FIG. 11B, the bitmap list (L) field may be three bits, but the current disclosure is not so limited, and the bitmap may be up to eight bits (i.e., the entire first octet 1160) when the network has configured eight lists of CCs on the UE.

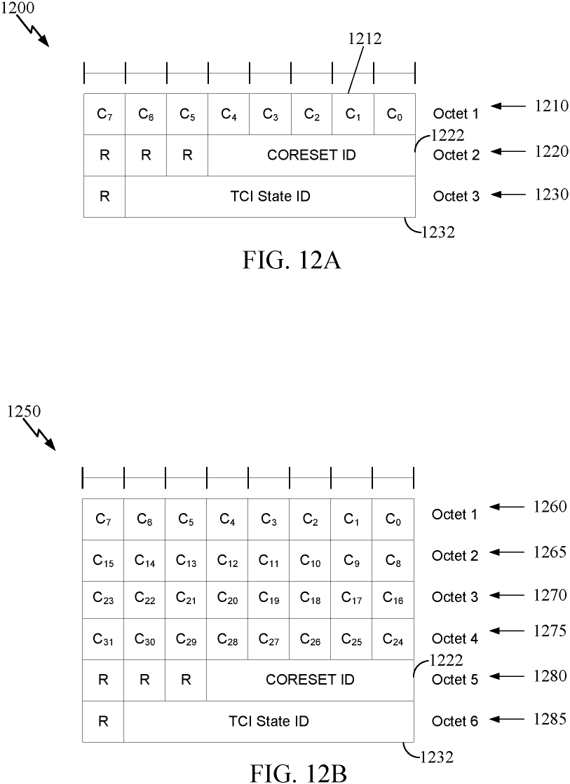

FIGS. 12A & 12B are diagrams of exemplary MAC CEs 1200 and 1250, according to aspects of the present disclosure. In aspects of the present disclosure, a MAC CE, which may be an example of the signal in block 505 of FIG. 5 or in block 605 of FIG. 6, may provide bitmap-based CC information. As illustrated at 1212 in FIG. 12A, the bitmap may include a plurality of C fields, with each C field indicating whether the TCI-states of the MAC CE apply to a corresponding CC configured on the receiving UE. As illustrated in MAC CE 1200, in some aspects of the present disclosure, the bitmap may be eight bits, i.e., the first octet 1210. In some aspects of the present disclosure, the bitmap may be 32 bits, i.e., the first four octets 1260, 1265, 1270, and 1275, as illustrated in MAC CE 1250. Octets after the bitmap (octets 1220 and 1230 in FIG. 12A or octets 1280 and 1285 in FIG. 12B) may indicate a coreset ID 1222 to which the TCI-state in MAC CE applies and a TCI-state ID 1232 that identifies the TCI-state to be applied to the PDCCH in the identified coreset.

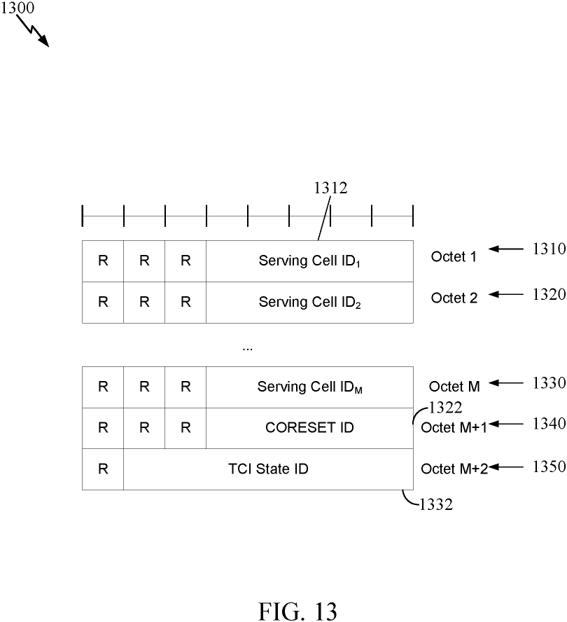

FIG. 13 is a diagram of an exemplary MAC CE 1300 in which serving cell IDs of a set of CCs to which the updated TCI-states in the MAC CE apply are explicitly listed. The MAC CE 1300 may include a set of M serving cell IDs in the first M octets 1310, 1320, and 1330 of the MAC CE, as shown at 1312. The MAC CE octets M+1 and M+2, shown at 1340 and 1350, may indicate a coreset ID 1322 to which the TCI-state in MAC CE applies and a TCI-state ID 1332 that identifies the TCI-state to be applied to the PDCCH in the identified coreset. The network may send (e.g., via a base station) a MAC CE 1300, which may be an example of the signal in block 505 of FIG. 5 or in block 605 of FIG. 6. The UE may then update the set of TCI-state information for the CCs corresponding to the serving cell IDs indicated in the MAC CE 1300.

According to aspects of the present disclosure, when a single PDCCH schedules a PDSCH to be transmitted via multiple transmission reception points (TRPs), that is, when a single downlink control information (DCI) is used to schedule a multiple TCI-state transmission, the TCI field in the DCI needs to indicate 2 TCI-states for the UE to receive the scheduled PDSCH.

In aspects of the present disclosure, each TCI code point in a DCI can correspond to 1 or 2 TCI-states.

The previously known techniques, discussed above with reference to FIG. 4, for MAC CE design for the multiple-TRP case focuses on the single cell (i.e., single CC) case only.

According to aspects of the present disclosure, the approaches discussed above with reference to FIGS. 7A, 7B, 8, 9A, 9B, 10, 11A, 11B, 12A, 12B, & 13 can be adopted for multiple TRP cases.

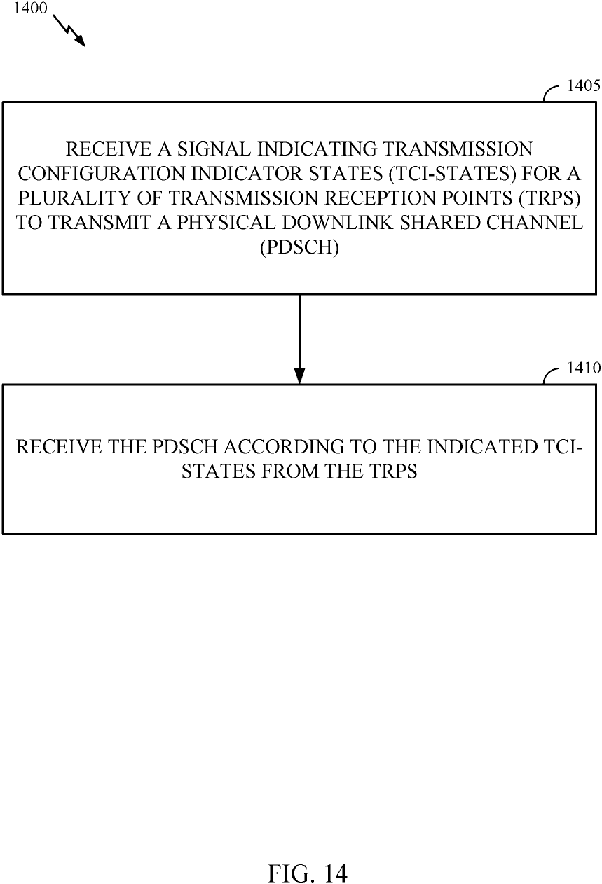

FIG. 14 is a flow diagram illustrating example operations 1400 for wireless communication, in accordance with certain aspects of the present disclosure. The operations 1400 may be performed, for example, by a UE (e.g., such as a UE 120a in the wireless communication network 100). Operations 1400 may be implemented as software components that are executed and run on one or more processors (e.g., controller/processor 280 of FIG. 2). Further, the transmission and reception of signals by the UE in operations 1400 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1400 may begin, at block 1405, by the UE receiving a signal indicating transmission configuration indicator states (TCI-states) for a plurality of transmission reception points (TRPs) to transmit a physical downlink shared channel (PDSCH). For example, the UE (e.g., UE 120a shown in FIGS. 1-2) receives a signal indicating TCI-states for a plurality of TRPs to transmit a PDSCH from a base station (e.g., BS 110a shown in FIGS. 1-2) via antennas 252. The UE may include one or more processors, such as the receive processor 258 and the controller/processor 280 of FIG. 2, to process the signal indicating the TCI-states for the plurality of TRPs to transmit a PDSCH. The processed information or resulting configuration may be stored in the data sink 260 or the memory 282.

At block 1410, operations 1400 continue with the UE receiving the PDSCH according to the indicated TCI-states from the TRPs. Continuing the example, the UE 120a of FIGS. 1-2 may, according to the indicated TCI-states from the TRPs, receive the PDSCH via the antennas 252.

In aspects of the present disclosure, a UE performing operations 1400 may receive, via radio resource control (RRC) signaling, a set of lists, each list including one or more component carriers (CCs) on which the plurality of TRPs of block 1405 are configured on the UE, and the PDCCH of block 1405 may indicate the plurality of TRPs by including an identifier of one of the lists in a field in the PDCCH.

According to aspects of the present disclosure, a UE performing operations 1400 may receive, via radio resource control (RRC) signaling, a set of lists, each list including one or more of the TRPs, and the PDCCH of block 1405 may indicate the plurality of TRPs in a bitmap in the PDCCH, wherein each bit in the bitmap indicates a corresponding list of one or more of the TRPs in the set of lists.

In aspects of the present disclosure, the PDCCH of block 1405 may include a bitmap, wherein each bit in the bitmap indicates whether the PDCCH indicates a corresponding TRP configured on the UE.

According to aspects of the present disclosure, the PDCCH of block 1405 may indicate the plurality of TRPs by including a list of cell identifiers (IDs) in the signal, each cell ID corresponding to one of the TRPs configured on the UE.

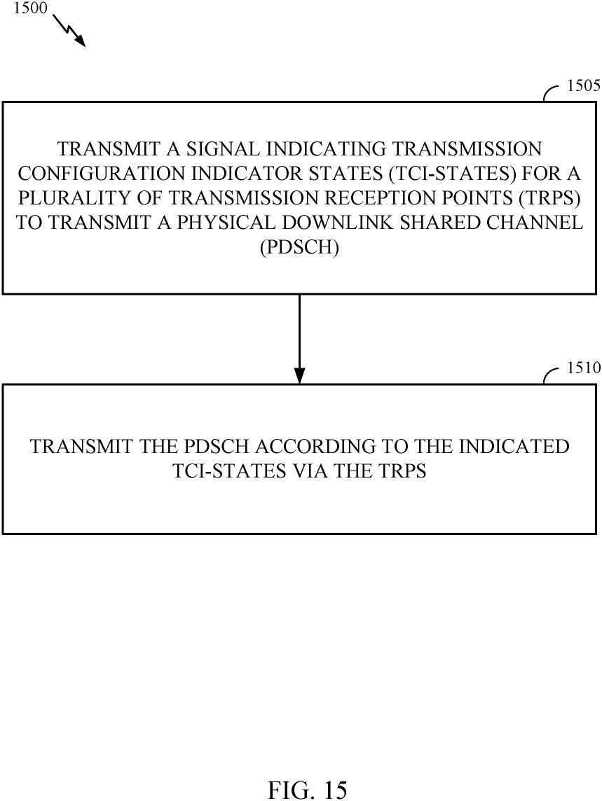

FIG. 15 is a flow diagram illustrating example operations 1500 for wireless communication, in accordance with certain aspects of the present disclosure. The operations 1500 may be performed, for example, by a BS (e.g., such as the BS 110a in the wireless communication network 100). The operations 1500 may be complementary operations by the BS to the operations 1400 performed by the UE. Operations 1500 may be implemented as software components that are executed and run on one or more processors (e.g., controller/processor 240 of FIG. 2). Further, the transmission and reception of signals by the BS in operations 1500 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 1500 may begin, at block 1505, by the BS transmitting a signal indicating transmission configuration indicator states (TCI-states) for a plurality of transmission reception points (TRPs) to transmit a physical downlink shared channel (PDSCH). For example, the BS may be the BS 110a of FIG. 2. The BS 110a may transmit a signal indicating TCI-states for a plurality of TRPs to transmit a PDSCH via antennas 234. The signal indicating the TCI-states for the plurality of TRPs may be generated or encoded by the controller/processor 240 and the transmit processor 220.

At block 1510, operations 1500 continue with the BS transmitting the PDSCH according to the indicated TCI-states via the TRPs. For example, the BS 110a of FIG. 2 may, according to the indicated TCI-states via the TRPs, transmit the PDSCH via the antennas 234.

In aspects of the present disclosure, a BS performing operations 1500 may transmit, via radio resource control (RRC) signaling, a set of lists, each list including one or more of the TRPs, and the BS may indicate the plurality of TRPs in the PDCCH of block 1505 by including an identifier of one of the lists of in a field in the PDCCH.

According to aspects of the present disclosure, a BS performing operations 1500 may transmit, via radio resource control (RRC) signaling, a set of lists, each list including one or more of the TRPs, and the BS may indicate the plurality of TRPs in a bitmap in the PDCCH of block 1505, wherein each bit in the bitmap indicates whether the PDCCH indicates a corresponding list of one or more of the TRPs in the set of lists.

In aspects of the present disclosure, a BS performing operations 1500 may include a bitmap in the PDCCH of block 1505, wherein each bit in the bitmap indicates whether the PDCCH indicates a corresponding TRP configured on a UE that is intended to receive the PDCCH and the PDSCH.

According to aspects of the present disclosure, BS performing operations 1500 may indicate the plurality of TRPs in the PDCCH of block 1505 by including a list of cell identifiers (IDs) in the signal, each cell ID corresponding to one of the TRPs configured on a UE that is intended to receive the PDCCH and the PDSCH.

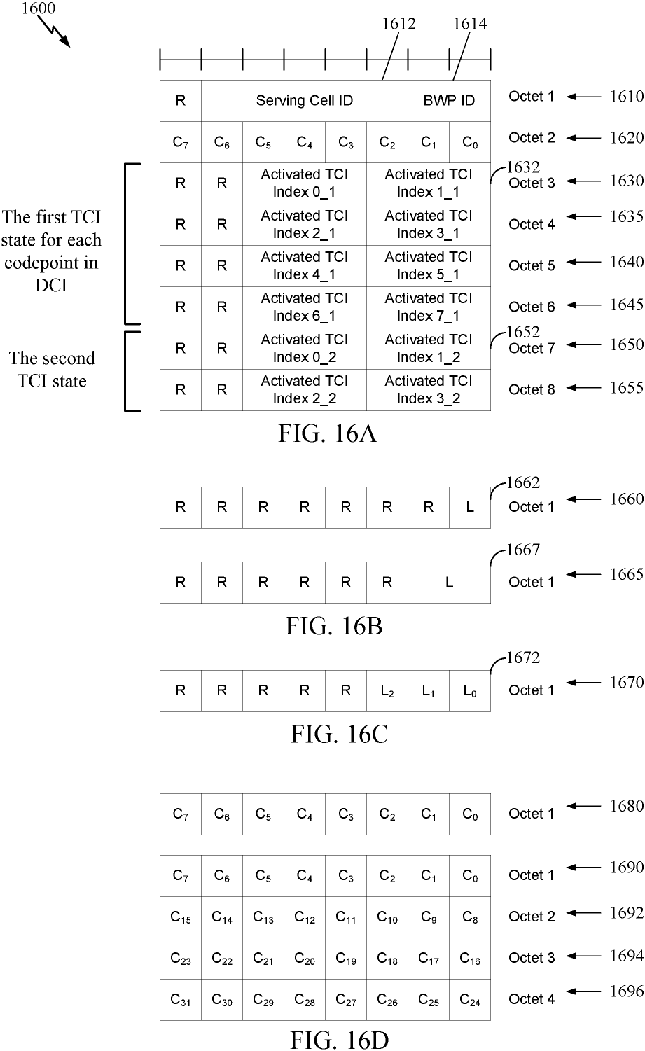

FIG. 16A illustrates an exemplary medium access control (MAC) control element (CE) 1600 for activating or deactivating TCI-states for a UE-specific physical downlink shared channel (PDSCH) sent via two transmission reception points (TRPs), according to previously known techniques (e.g., Rel-15). The exemplary MAC CE includes a plurality of octets 1610, 1620, 1630, 1635, 1640, 1645, 1650, 1655, etc. The first octet 1610 includes a Serving Cell ID field 1612, which is five bits long and indicates the identity of the serving cell for which the MAC CE applies. The first octet also includes a BWP ID field 1614 that is two bits long and indicates a downlink (DL) bandwidth part (BWP) for which the MAC CE applies as the codepoint of the downlink control information (DCI) bandwidth part indicator field. The third octet 1630 and later octets 1635, 1640, and 1645 include sets of bits (e.g., set 1632) indicating a set of first activated TCI states for the serving cell ID and BWP ID for each codepoint in a DCI. The seventh octet 1650 and later octets 1655, etc. include sets of bits (e.g., set 1652) indicating a set of a second activated TCI states for the serving cell ID and BWP ID for each codepoint in a DCI. The maximum number of activated TCI states for each codepoint may be 8. As with the MAC CE 300 illustrated in FIG. 3, the network must send a separate MAC CE 1600 for each component carrier.

According to aspects of the present disclosure, the first octet of the MAC CE 1600 in FIG. 16A may include bits to indicate a list of CCs, a bitmap indicating one or more lists of CCs, or a bitmap indicating one or more CCs configured on a receiving UE.

FIG. 16B illustrates exemplary octets 1660 and 1665 that may replace the first octet 1610 in an exemplary MAC CE 1600, according to aspects of the present disclosure. With the exemplary octet 1660, an L field 1662 indicates whether the MAC CE 1600 applies to a list of CCs sent to the UE via RRC signaling. According to aspects of the present disclosure, the network (e.g., a base station) may use radio resource control (RRC) signaling to configure lists of CCs on a UE. The network may send (e.g., via a base station) a MAC CE 1600, which may be an example of the signal in block 505 of FIG. 5 or in block 605 of FIG. 6, that has an L field 1662 or 1667 that indicates one of the lists configured by the RRC signaling. The UE may then update the set of TCI-state information for the CCs in the list indicated in the MAC CE 1600. The L field 1662 is illustrated as one bit, enabling the network and UE to refer to one of two lists of CCs, but the present disclosure is not so limited. The L field may be two (e.g., L field 1667) or more bits, enabling the network and UE to refer more than two lists of CCs.

FIG. 16C illustrates an exemplary octet 1670 that may replace the first octet 1610 in an exemplary MAC CE 1600, according to aspects of the present disclosure. With the exemplary octet 1670, a bitmap in the MAC CE 1600 indicates a set of lists of CCs to which the activated TCI-states in the MAC CE apply. The MAC CE 1600 may include a set of list (L) fields in the first octet, as shown at 1672 in FIG. 16C. According to aspects of the present disclosure, the network (e.g., a base station) may use radio resource control (RRC) signaling to configure lists of CCs on a UE. The network may send (e.g., via a base station) a MAC CE 1600, which may be an example of the signal in block 505 of FIG. 5 or in block 605 of FIG. 6, that has a bitmap which indicates one or more of the lists configured by the RRC signaling. The UE may then update the set of TCI-state information for the CCs in the one or more lists indicated in the MAC CE. As illustrated at 1672 in FIG. 16C, the bitmap list (L) field may be three bits, but the current disclosure is not so limited, and the bitmap may be up to eight bits (i.e., the entire first octet) when the network has configured eight lists of CCs on the UE.

FIG. 16D illustrates exemplary octet 1680 and exemplary set of octets 1690, 1692, 1694, and 1696 that may replace the first octet 1610 in an exemplary MAC CE 1600, according to aspects of the present disclosure. With the exemplary octet 1680, a bitmap in the MAC CE 1600 indicates a set of CCs configured on a receiving UE to which the activated TCI-states in the MAC CE 1600 apply. In aspects of the present disclosure, a MAC CE 1600, which may be an example of the signal in block 505 of FIG. 5 or in block 605 of FIG. 6, may provide bitmap-based CC information. As illustrated, the bitmap may include a plurality of C fields, with each C field indicating whether the activated TCI-states of the MAC CE apply to a corresponding CC configured on the receiving UE. As illustrated in the exemplary octet 1680, in some aspects of the present disclosure, the bitmap may be eight bits, i.e., the first octet 1610. In some aspects of the present disclosure, the bitmap may be 32 bits, i.e., the first four octets 1690, 1692, 1694, and 1696, as illustrated.

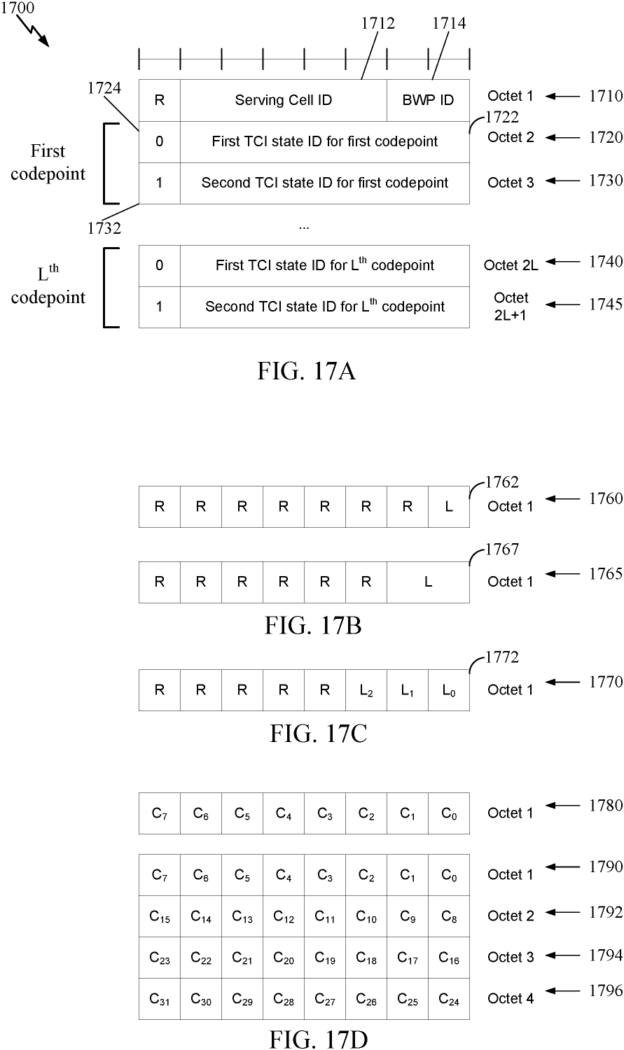

FIG. 17A illustrates an exemplary medium access control (MAC) control element (CE) 1700 for activating or deactivating TCI-states for a UE-specific physical downlink shared channel (PDSCH) sent via two transmission reception points (TRPs), according to previously known techniques (e.g., Rel-15). The exemplary MAC CE includes a plurality of octets 1710, 1720, 1730, etc. The first octet 1710 includes a Serving Cell ID field 1712, which is five bits long and indicates the identity of the serving cell for which the MAC CE applies. The first octet also includes a BWP ID field 1714 that is two bits long and indicates a downlink (DL) bandwidth part (BWP) for which the MAC CE applies as the codepoint of the downlink control information (DCI) bandwidth part indicator field. The second octet 1720 and later octets 1730, 1740, and 1745 include sets of bits (e.g., set 1722 and 1724) that indicate a TCI state ID for an activated TCI-state for a codepoint and whether that TCI-state is the first TCI-state for the codepoint or the second TCI-state for the codepoint. As illustrated, the second octet 1720 and the third octet 1730 include the first TCI state ID and the second TCI state ID for the first codepoint of a DCI. The first bit (e.g., bits 1724 and 1732) of each octet may be set to 0 to indicate that the TCI state ID is the first TCI state ID for a codepoint and may be set to 1 to indicate that the TCI state ID is the second TCI state ID for a codepoint. Each additional pair of octets (e.g., octets 1740 and 1745) include the first TCI state ID and the second TCI state ID for an additional codepoint of a DCI. As with the MAC CE 300 illustrated in FIG. 3, the network must send a separate MAC CE 1700 for each component carrier.

According to aspects of the present disclosure, the first octet of the MAC CE 1700 in FIG. 17A may include bits to indicate a list of CCs, a bitmap indicating one or more lists of CCs, or a bitmap indicating one or more CCs configured on a receiving UE.

FIG. 17B illustrates exemplary octets 1760 and 1765 that may replace the first octet 1710 in an exemplary MAC CE 1700, according to aspects of the present disclosure. With the exemplary octet 1760, an L field 1762 indicates whether the MAC CE 1700 applies to a list of CCs sent to the UE via RRC signaling. According to aspects of the present disclosure, the network (e.g., a base station) may use radio resource control (RRC) signaling to configure lists of CCs on a UE. The network may send (e.g., via a base station) a MAC CE 1700, which may be an example of the signal in block 505 of FIG. 5 or in block 605 of FIG. 6, that has an L field 1762 or 1767 that indicates one of the lists configured by the RRC signaling. The UE may then update the set of TCI-state information for the CCs in the list indicated in the MAC CE 1700. The L field 1762 is illustrated as one bit, enabling the network and UE to refer to one of two lists of CCs, but the present disclosure is not so limited. The L field may be two (e.g., L field 1767) or more bits, enabling the network and UE to refer more than two lists of CCs.

FIG. 17C illustrates an exemplary octet 1770 that may replace the first octet 1710 in an exemplary MAC CE 1700, according to aspects of the present disclosure. With the exemplary octet 1770, a bitmap in the MAC CE 1700 indicates a set of lists of CCs to which the activated TCI-states in the MAC CE apply. The MAC CE 1700 may include a set of list (L) fields in the first octet, as shown at 1772 in FIG. 17C. According to aspects of the present disclosure, the network (e.g., a base station) may use radio resource control (RRC) signaling to configure lists of CCs on a UE. The network may send (e.g., via a base station) a MAC CE 1700, which may be an example of the signal in block 505 of FIG. 5 or in block 605 of FIG. 6, that has a bitmap which indicates one or more of the lists configured by the RRC signaling. The UE may then update the set of TCI-state information for the CCs in the one or more lists indicated in the MAC CE. As illustrated at 1772 in FIG. 17C, the bitmap list (L) field may be three bits, but the current disclosure is not so limited, and the bitmap may be up to eight bits (i.e., the entire first octet) when the network has configured eight lists of CCs on the UE.

FIG. 17D illustrates exemplary octet 1780 and exemplary set of octets 1790, 1792, 1794, and 1796 that may replace the first octet 1710 in an exemplary MAC CE 1700, according to aspects of the present disclosure. With the exemplary octet 1780, a bitmap in the MAC CE 1700 indicates a set of CCs configured on a receiving UE to which the activated TCI-states in the MAC CE 1700 apply. In aspects of the present disclosure, a MAC CE 1700, which may be an example of the signal in block 505 of FIG. 5 or in block 605 of FIG. 6, may provide bitmap-based CC information. As illustrated, the bitmap may include a plurality of C fields, with each C field indicating whether the activated TCI-states of the MAC CE apply to a corresponding CC configured on the receiving UE. As illustrated in the exemplary octet 1780, in some aspects of the present disclosure, the bitmap may be eight bits, i.e., the first octet 1710. In some aspects of the present disclosure, the bitmap may be 32 bits, i.e., the first four octets 1790, 1792, 1794, and 1796, as illustrated.

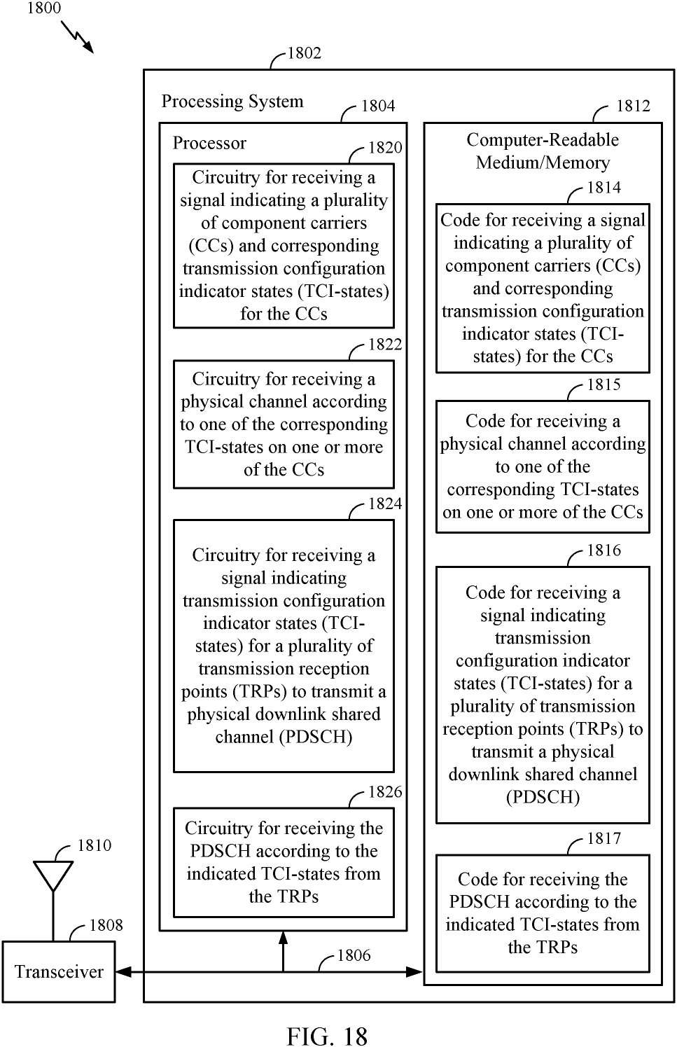

FIG. 18 illustrates a communications device 1800 that may include various components (e.g., corresponding to means-plus-function components) configured to perform operations for the techniques disclosed herein, such as the operations illustrated in FIGS. 5 & 14. The communications device 1800 includes a processing system 1802 coupled to a transceiver 1808. The transceiver 1808 is configured to transmit and receive signals for the communications device 1800 via an antenna 1810, such as the various signals as described herein. The processing system 1802 may be configured to perform processing functions for the communications device 1800, including processing signals received and/or to be transmitted by the communications device 1800.

The processing system 1802 includes a processor 1804 coupled to a computer-readable medium/memory 1812 via a bus 1806. In certain aspects, the computer-readable medium/memory 1812 is configured to store instructions (e.g., computer-executable code) that when executed by the processor 1804, cause the processor 1804 to perform the operations illustrated in FIGS. 5 & 14, or other operations for performing the various techniques discussed herein for updating transmission configuration indicator states (TCI-states) for user equipment (UE) specific transmissions via multiple component carriers. In certain aspects, computer-readable medium/memory 1812 stores code 1814 for receiving a signal indicating a plurality of component carriers (CCs) and corresponding transmission configuration indicator states (TCI-states) for the CCs; code 1815 for receiving a physical channel according to one of the corresponding TCI-states on one or more of the CCs; code 1816 for receiving a signal indicating transmission configuration indicator states (TCI-states) for a plurality of transmission reception points (TRPs) to transmit a physical downlink shared channel (PDSCH); and code 1817 for receiving the PDSCH according to the indicated TCI-states from the TRPs. In certain aspects, the processor 1804 has circuitry (e.g., an example of means for) configured to implement the code stored in the computer-readable medium/memory 1812. The processor 1804 includes circuitry (e.g., an example of means for) 1820 for receiving a signal indicating a plurality of component carriers (CCs) and corresponding transmission configuration indicator states (TCI-states) for the CCs; circuitry (e.g., an example of means for) 1822 for receiving a physical channel according to one of the corresponding TCI-states on one or more of the CCs; circuitry (e.g., an example of means for) 1824 for receiving a signal indicating transmission configuration indicator states (TCI-states) for a plurality of transmission reception points (TRPs) to transmit a physical downlink shared channel (PDSCH); and circuitry (e.g., an example of means for) 1826 for receiving the PDSCH according to the indicated TCI-states from the TRPs. One or more of circuitry 1820, 1822, 1824, and 1826 may be implemented by one or more of a digital signal processor (DSP), a circuit, an application specific integrated circuit (ASIC), or a processor (e.g., a general purpose or specifically programmed processor).

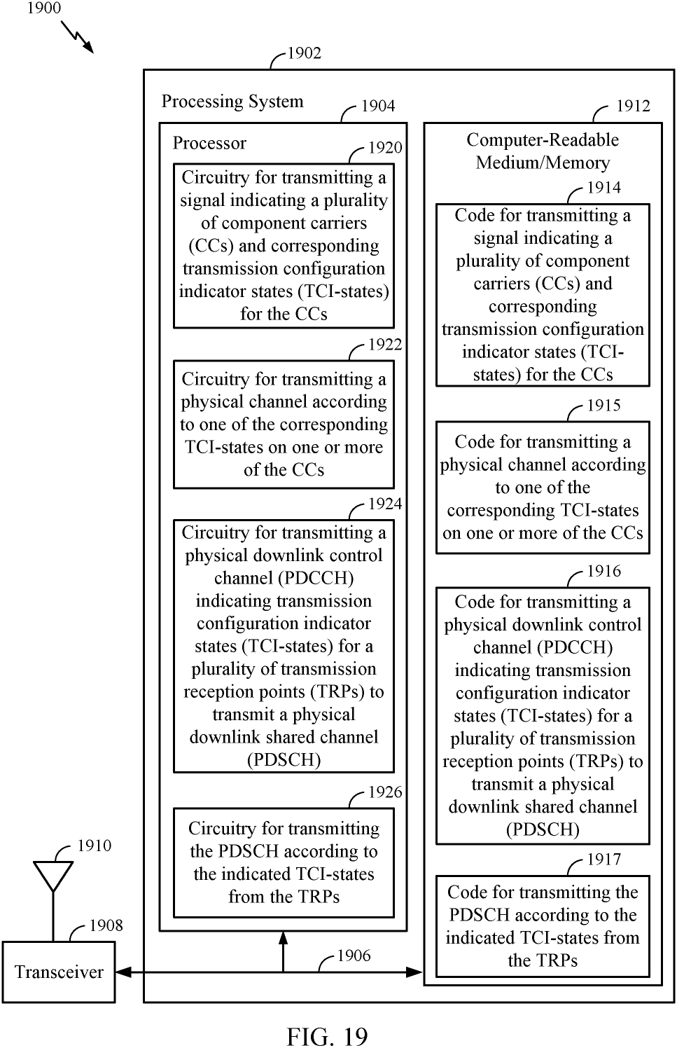

FIG. 19 illustrates a communications device 1900 that may include various components (e.g., corresponding to means-plus-function components) configured to perform operations for the techniques disclosed herein, such as the operations illustrated in FIGS. 6 & 15. The communications device 1900 includes a processing system 1902 coupled to a transceiver 1908. The transceiver 1908 is configured to transmit and receive signals for the communications device 1900 via an antenna 1910, such as the various signals as described herein. The processing system 1902 may be configured to perform processing functions for the communications device 1900, including processing signals received and/or to be transmitted by the communications device 1900.

The processing system 1902 includes a processor 1904 coupled to a computer-readable medium/memory 1912 via a bus 1906. In certain aspects, the computer-readable medium/memory 1912 is configured to store instructions (e.g., computer-executable code) that when executed by the processor 1904, cause the processor 1904 to perform the operations illustrated in FIGS. 6 & 15, or other operations for performing the various techniques discussed herein for updating transmission configuration indicator states (TCI-states) for user equipment (UE) specific transmissions via multiple component carriers. In certain aspects, computer-readable medium/memory 1912 stores code 1914 for transmitting a signal indicating a plurality of component carriers (CCs) and corresponding transmission configuration indicator states (TCI-states) for the CCs; code 1915 for transmitting a physical channel according to one of the corresponding TCI-states on one or more of the CCs; code 1916 for transmitting a signal indicating transmission configuration indicator states (TCI-states) for a plurality of transmission reception points (TRPs) to transmit a physical downlink shared channel (PDSCH); and code 1917 for transmitting the PDSCH according to the indicated TCI-states from the TRPs. In certain aspects, the processor 1904 has circuitry (e.g., an example of means for) configured to implement the code stored in the computer-readable medium/memory 1912. The processor 1904 includes circuitry (e.g., an example of means for) 1920 for transmitting a signal indicating a plurality of component carriers (CCs) and corresponding transmission configuration indicator states (TCI-states) for the CCs; circuitry (e.g., an example of means for) 1922 for transmitting a physical channel according to one of the corresponding TCI-states on one or more of the CCs; circuitry (e.g., an example of means for) 1924 for transmitting a signal indicating transmission configuration indicator states (TCI-states) for a plurality of transmission reception points (TRPs) to transmit a physical downlink shared channel (PDSCH); and circuitry (e.g., an example of means for) 1926 for transmitting the PDSCH according to the indicated TCI-states from the TRPs. One or more of circuitry 1920, 1922, 1924, and 1926 may be implemented by one or more of a digital signal processor (DSP), a circuit, an application specific integrated circuit (ASIC), or a processor (e.g., a general purpose or specifically programmed processor).

### Example Aspects

Aspect 1: An apparatus for wireless communications, comprising: a memory; and a processor coupled with the memory, the memory and the processor configured to: receive a signal indicating a plurality of component carriers (CCs) and corresponding transmission configuration indicator states (TCI-states) for the CCs; and receive a physical channel according to one of the corresponding TCI-states on one or more of the CCs.

Aspect 2: The apparatus of Aspect 1, wherein the signal comprises a medium access control (MAC) control element (CE).

Aspect 3: The apparatus of Aspect 1, wherein the memory and the processor are further configured to: receive, via radio resource control (RRC) signaling, a set of lists, wherein each list includes one or more of the CCs and wherein indicating the plurality of CCs comprises including an identifier of one of the lists in a field in the signal.

Aspect 4: The apparatus of Aspect 1, wherein the memory and the processor are further configured to: receive, via radio resource control (RRC) signaling, a set of lists, wherein each list includes one or more of the CCs, wherein indicating the plurality of CCs comprises including a bitmap in the signal, and wherein each bit in the bitmap indicates whether the signal applies to a corresponding list in the set of lists.

Aspect 5: The apparatus of Aspect 1, wherein indicating the plurality of CCs comprises including a bitmap in the signal, wherein each bit in the bitmap indicates whether the signal applies to a corresponding cell operating on at least one of the CCs and configured on the apparatus.

Aspect 6: The apparatus of Aspect 1, wherein indicating the plurality of CCs comprises including a list of cell identifiers (IDs) in the signal, each cell ID corresponding to a cell operating on at least one of the CCs and configured on the apparatus.

Aspect 7: The apparatus of Aspect 1, wherein the physical channel comprises a physical downlink control channel (PDCCH).

Aspect 8: The apparatus of Aspect 1, wherein the physical channel comprises a physical downlink shared channel (PDSCH).

Aspect 9: The apparatus of Aspect 1, wherein the physical channel comprises a downlink control information (DCI) comprising at least a first codepoint and a second codepoint, and wherein the signal indicates a first plurality of activated TCI-states corresponding to the first codepoint and a second plurality of activated TCI-states corresponding to the second codepoint.

Aspect 10: An apparatus for wireless communications, comprising: a memory; and a processor coupled with the memory, the memory and the processor configured to: transmit a signal indicating a plurality of component carriers (CCs) and corresponding transmission configuration indicator states (TCI-states) for the CCs; and transmit a physical channel according to one of the corresponding TCI-states on one or more of the CCs.

Aspect 11: The apparatus of Aspect 10, wherein the signal comprises a medium access control (MAC) control element (CE).

Aspect 12: The apparatus of Aspect 10, wherein the memory and the processor are further configured to: transmit, via radio resource control (RRC) signaling, a set of lists, each list including one or more of the CCs; and indicate the plurality of CCs in the signal by including an identifier of one of the lists in a field in the signal.

Aspect 13: The apparatus of Aspect 10, wherein the memory and the processor are further configured to: transmit, via radio resource control (RRC) signaling, a set of lists, each list including one or more of the CCs; and indicate the plurality of CCs in a bitmap in the signal, wherein each bit in the bitmap indicates whether the signal applies to a corresponding list in the set of lists.

Aspect 14: The apparatus of Aspect 10, wherein the memory and the processor are further configured to include a bitmap in the signal, wherein each bit in the bitmap indicates whether the signal applies to a corresponding cell operating on at least one of the CCs and configured on a UE that is intended to receive the signal and the physical channel.

Aspect 15: The apparatus of Aspect 10, wherein the memory and the processor are further configured to indicate the plurality of CCs in the signal by including a list of cell identifiers (IDs) in the signal, each cell ID corresponding to a cell operating on at least one of the CCs and configured on a UE that is intended to receive the signal and the physical channel.

Aspect 16: The apparatus of Aspect 10, wherein the physical channel comprises a physical downlink control channel (PDCCH).

Aspect 17: The apparatus of Aspect 10, wherein the physical channel comprises a physical downlink shared channel (PDSCH).

Aspect 18: The apparatus of Aspect 10, wherein the physical channel comprises a downlink control information (DCI) comprising at least a first codepoint and a second codepoint, and wherein the signal indicates a first plurality of activated TCI-states corresponding to the first codepoint and a second plurality of activated TCI-states corresponding to the second codepoint.

Aspect 19: An apparatus for wireless communications, comprising: a memory; and a processor coupled with the memory, the memory and the processor configured to: receive a signal indicating transmission configuration indicator states (TCI-states) for a plurality of transmission reception points (TRPs) to transmit a physical downlink shared channel (PDSCH); and receive the PDSCH according to the indicated TCI-states from the TRPs.

Aspect 20: The apparatus of Aspect 19, wherein the signal comprises a medium access control (MAC) control element (CE).

Aspect 21: The apparatus of Aspect 19, wherein the memory and the processor are further configured to receive, via radio resource control (RRC) signaling, a set of lists, each list including one or more component carriers (CCs) on which the plurality of TRPs are configured on the apparatus, wherein the signal comprises an identifier that indicates a corresponding list of the CCs.

Aspect 22: The apparatus of Aspect 19, wherein the memory and the processor are further configured to receive, via radio resource control (RRC) signaling, a set of lists, each list including one or more component carriers (CCs) on which the plurality of TRPs are configured on the apparatus, wherein the signal comprises a bitmap, wherein each bit in the bitmap indicates a corresponding list of one or more of the CCs.

Aspect 23: The apparatus of Aspect 19, wherein the signal comprises a list of cell identifiers (IDs), each cell ID corresponding to a component carrier (CC) on which one or more of the plurality of TRPs are configured on the apparatus.

Aspect 24: The apparatus of Aspect 19, wherein the memory and the processor are further configured to receive a physical channel that comprises a downlink control information (DCI) comprising at least a first codepoint and a second codepoint and wherein the signal indicates a first plurality of activated TCI-states corresponding to the first codepoint and a second plurality of activated TCI-states corresponding to the second codepoint.

Aspect 25: An apparatus for wireless communications performed, comprising: a memory; and a processor coupled with the memory, the memory and the processor configured to: transmit a signal indicating transmission configuration indicator states (TCI-states) for a plurality of transmission reception points (TRPs) to transmit a physical downlink shared channel (PDSCH); and transmit the PDSCH according to the indicated TCI-states via the TRPs.

Aspect 26: The apparatus of Aspect 25, wherein the signal comprises a medium access control (MAC) control element (CE).

Aspect 27: The apparatus of Aspect 25, wherein the memory and the processor are further configured to: transmit, via radio resource control (RRC) signaling, a set of lists, each list including one or more component carriers (CCs) on which the TRPs are configured on a user equipment (UE) that is intended to receive the PDSCH; and include an identifier of one of the lists in a field in the signal, wherein the identifier indicates a corresponding list of the CCs.

Aspect 28: The apparatus of Aspect 25, wherein the memory and the processor are further configured to: transmit, via radio resource control (RRC) signaling, a set of lists, each list including one or more component carriers (CCs) on which the plurality of TRPs are configured on a user equipment (UE) that is intended to receive the PDSCH; and include a bitmap in the signal, wherein each bit in the bitmap indicates a corresponding list of one or more of the CCs.

Aspect 29: The apparatus of Aspect 25, wherein the memory and the processor are further configured to include a list of cell identifiers (IDs) in the signal, each cell ID corresponding to a component carrier (CC) on which one or more of the plurality of TRPs are configured on a UE that is intended to receive the PDSCH.

Aspect 30: The apparatus of Aspect 25, wherein the memory and the processor are further configured to transmit a physical channel that comprises a downlink control information (DCI) comprising at least a first codepoint and a second codepoint and wherein the signal indicates a first plurality of activated TCI-states corresponding to the first codepoint and a second plurality of activated TCI-states corresponding to the second codepoint.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The techniques described herein may be used for the wireless networks and radio technologies mentioned above as well as other wireless networks and radio technologies. For clarity, while aspects may be described herein using terminology commonly associated with 3G, 4G, and/or 5G wireless technologies, aspects of the present disclosure can be applied in other generation-based communication systems.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (e.g., 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe.

NR may utilize OFDM with a CP on the uplink and downlink and include support for half-duplex operation using TDD. In NR, a subframe is still 1 ms, but the basic TTI is referred to as a slot. A subframe contains a variable number of slots (e.g., 1, 2, 4, 8, 16, ... slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 5, 6, 14 and/or 15.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications, comprising:
a memory; and
a processor coupled with the memory, the memory and the processor configured to:
receive a signal indicating a plurality of component carriers (CCs) and corresponding transmission configuration indicator states (TCI-states) for the CCs; and
receive a physical channel according to one of the corresponding TCI-states on one or more of the CCs.

2. The apparatus of claim 1, wherein the signal comprises a medium access control (MAC) control element (CE).

3. The apparatus of claim 1, wherein the memory and the processor are further configured to:
receive, via radio resource control (RRC) signaling, a set of lists, wherein each list includes one or more of the CCs and wherein indicating the plurality of CCs comprises including an identifier of one of the lists in a field in the signal.

4. The apparatus of claim 1, wherein the memory and the processor are further configured to:
receive, via radio resource control (RRC) signaling, a set of lists, wherein each list includes one or more of the CCs, wherein indicating the plurality of CCs comprises including a bitmap in the signal, and wherein each bit in the bitmap indicates whether the signal applies to a corresponding list in the set of lists.

5. The apparatus of claim 1, wherein indicating the plurality of CCs comprises including a bitmap in the signal, wherein each bit in the bitmap indicates whether the signal applies to a corresponding cell operating on at least one of the CCs and configured on the apparatus.

6. The apparatus of claim 1, wherein indicating the plurality of CCs comprises including a list of cell identifiers (IDs) in the signal, each cell ID corresponding to a cell operating on at least one of the CCs and configured on the apparatus.

7. The apparatus of claim 1, wherein the physical channel comprises a physical downlink control channel (PDCCH).

8. The apparatus of claim 1, wherein the physical channel comprises a physical downlink shared channel (PDSCH).

9. The apparatus of claim 1, wherein the physical channel comprises a downlink control information (DCI) comprising at least a first codepoint and a second codepoint, and wherein the signal indicates a first plurality of activated TCI-states corresponding to the first codepoint and a second plurality of activated TCI-states corresponding to the second codepoint.

10. An apparatus for wireless communications, comprising:
a memory; and
a processor coupled with the memory, the memory and the processor configured to:
transmit a signal indicating a plurality of component carriers (CCs) and corresponding transmission configuration indicator states (TCI-states) for the CCs; and
transmit a physical channel according to one of the corresponding TCI-states on one or more of the CCs.

11. The apparatus of claim 10, wherein the signal comprises a medium access control (MAC) control element (CE).

12. The apparatus of claim 10, wherein the memory and the processor are further configured to:
transmit, via radio resource control (RRC) signaling, a set of lists, each list including one or more of the CCs; and
indicate the plurality of CCs in the signal by including an identifier of one of the lists in a field in the signal.

13. The apparatus of claim 10, wherein the memory and the processor are further configured to:
transmit, via radio resource control (RRC) signaling, a set of lists, each list including one or more of the CCs; and
indicate the plurality of CCs in a bitmap in the signal, wherein each bit in the bitmap indicates whether the signal applies to a corresponding list in the set of lists.

14. The apparatus of claim 10, wherein the memory and the processor are further configured to include a bitmap in the signal, wherein each bit in the bitmap indicates whether the signal applies to a corresponding cell operating on at least one of the CCs and configured on a UE that is intended to receive the signal and the physical channel.

15. The apparatus of claim 10, wherein the memory and the processor are further configured to indicate the plurality of CCs in the signal by including a list of cell identifiers (IDs) in the signal, each cell ID corresponding to a cell operating on at least one of the CCs and configured on a UE that is intended to receive the signal and the physical channel.

16. The apparatus of claim 10, wherein the physical channel comprises a physical downlink control channel (PDCCH).

17. The apparatus of claim 10, wherein the physical channel comprises a physical downlink shared channel (PDSCH).

18. The apparatus of claim 10, wherein the physical channel comprises a downlink control information (DCI) comprising at least a first codepoint and a second codepoint, and wherein the signal indicates a first plurality of activated TCI-states corresponding to the first codepoint and a second plurality of activated TCI-states corresponding to the second codepoint.

19. An apparatus for wireless communications, comprising:
a memory; and
a processor coupled with the memory, the memory and the processor configured to:
receive a signal indicating transmission configuration indicator states (TCI-states) for a plurality of transmission reception points (TRPs) to transmit a physical downlink shared channel (PDSCH); and
receive the PDSCH according to the indicated TCI-states from the TRPs.

20. The apparatus of claim 19, wherein the signal comprises a medium access control (MAC) control element (CE).

21. The apparatus of claim 19, wherein the memory and the processor are further configured to receive, via radio resource control (RRC) signaling, a set of lists, each list including one or more component carriers (CCs) on which the plurality of TRPs are configured on the apparatus, wherein the signal comprises an identifier that indicates a corresponding list of the CCs.

22. The apparatus of claim 19, wherein the memory and the processor are further configured to receive, via radio resource control (RRC) signaling, a set of lists, each list including one or more component carriers (CCs) on which the plurality of TRPs are configured on the apparatus, wherein the signal comprises a bitmap, wherein each bit in the bitmap indicates a corresponding list of one or more of the CCs.

23. The apparatus of claim 19, wherein the signal comprises a list of cell identifiers (IDs), each cell ID corresponding to a component carrier (CC) on which one or more of the plurality of TRPs are configured on the apparatus.

24. The apparatus of claim 19, wherein the memory and the processor are further configured to receive a physical channel that comprises a downlink control information (DCI) comprising at least a first codepoint and a second codepoint and wherein the signal indicates a first plurality of activated TCI-states corresponding to the first codepoint and a second plurality of activated TCI-states corresponding to the second codepoint.

25. An apparatus for wireless communications performed, comprising:
a memory; and
a processor coupled with the memory, the memory and the processor configured to:
transmit a signal indicating transmission configuration indicator states (TCI-states) for a plurality of transmission reception points (TRPs) to transmit a physical downlink shared channel (PDSCH); and
transmit the PDSCH according to the indicated TCI-states via the TRPs.

26. The apparatus of claim 25, wherein the signal comprises a medium access control (MAC) control element (CE).

27. The apparatus of claim 25, wherein the memory and the processor are further configured to:
transmit, via radio resource control (RRC) signaling, a set of lists, each list including one or more component carriers (CCs) on which the TRPs are configured on a user equipment (UE) that is intended to receive the PDSCH; and
include an identifier of one of the lists in a field in the signal, wherein the identifier indicates a corresponding list of the CCs.

28. The apparatus of claim 25, wherein the memory and the processor are further configured to:
transmit, via radio resource control (RRC) signaling, a set of lists, each list including one or more component carriers (CCs) on which the plurality of TRPs are configured on a user equipment (UE) that is intended to receive the PDSCH; and
include a bitmap in the signal, wherein each bit in the bitmap indicates a corresponding list of one or more of the CCs.

29. The apparatus of claim 25, wherein the memory and the processor are further configured to include a list of cell identifiers (IDs) in the signal, each cell ID corresponding to a component carrier (CC) on which one or more of the plurality of TRPs are configured on a UE that is intended to receive the PDSCH.

30. The apparatus of claim 25, wherein the memory and the processor are further configured to transmit a physical channel that comprises a downlink control information (DCI) comprising at least a first codepoint and a second codepoint and wherein the signal indicates a first plurality of activated TCI-states corresponding to the first codepoint and a second plurality of activated TCI-states corresponding to the second codepoint.
